(19) United States
(12) Patent Application Publication
(10) Pub. No.: US 2025/0319636 A1
(43) Pub. Date: Oct. 16, 2025

(54) METHOD FOR GENERATING PROCESSING PARAMETERS OF TIRES TO ACHIEVE THE DESIRED PROPERTIES OF RUBBER CRUMB AND THE GENERATION SYSTEM THEREOF

(71) Applicant: INDUSTRIAL TECHNOLOGY RESEARCH INSTITUTE, Hsinchu (TW)

(72) Inventors: CHUN-YU CHEN, Taichung City (TW); PAO-MIN HUANG, Yunlin County (TW); JUI-LIN CHENG, Tainan City (TW); PIN-TSUNG CHENG, Kaohsiung City (TW)

(21) Appl. No.: 18/632,627

(22) Filed: Apr. 11, 2024

(51) Int. Cl. B29B 17/04; G05B 13/04

(52) U.S. Cl. CPC B29B 17/0404; G05B 13/042; B29B 2017/0432

(57) ABSTRACT

A method for generating processing parameters of tires to achieve the desired properties of rubber crumb, adapted to establish in a software program and executed in the following steps after read by a computer: establishing a predictive processing model through a waterjet tire destructing processing module, including the following steps: inputting waterjet data in a waterjet database; performing data analysis on the waterjet data to normalize the waterjet data; establishing the predictive processing model according to the normalized waterjet data; and training the predictive processing model to obtain the training result of a predictive chemical activity value; and outputting a processing suggestion parameter through a waterjet technology parameter optimization module and the predictive processing model. In addition, a generation system is also proposed.

### TECHNICAL FIELD

The present disclosure relates to a method for generating processing parameters, and more particularly to a method for generating processing parameters of tires to achieve the desired properties of rubber crumb.

### BACKGROUND

At present, waste tires are mostly mechanically crushed and used as tire derived fuel (TDF), which can easily cause pollution to the environment and ecology. As society pays more attention to environmental protection and the utilization of renewable resources, it no longer meets the needs of circular economy. For this reason, the current technology for processing waste tires is based on material recycling. How to convert waste tires into recycled materials is one of the important topics. However, although waste tires are useful resources, they are thermosetting polymer materials, such that the recycling thereof exists difficulties that are not easy to overcome.

Traditional waste tire recycling methods include freezing, chemical, or mechanical methods. In recent years, waste tire recycling using waterjet technology has gradually become an emerging market, which is based on water bodies (clean water) as the medium, using high-pressure water jet technology to recycle waste tires, which will not damage the steel wires in the tires, and has the advantages of low processing cost, high production efficiency, high production capacity, low energy consumption, high recovery rate, and clean separation of rubber crumb, greatly improving the existing waste tire recycling and recycling technology and processing equipment, gradually becoming a new revolution in waste tire recycling processing technology.

However, the current water jet technology can only adjust the processing parameters in the trial processing stage before mass production based on personal experience to obtain the target rubber crumb with required activity. However, everyone's experience is different and the empirical data is too subjective. In addition, the product conditions of each waste tire are different, which makes debugging process parameters quite time-consuming and requires trial and error to debug the required process parameters. In addition, problems such as environmental pollution and energy waste are often caused during the debugging process.

### SUMMARY

The present disclosure discloses a method for generating processing parameters of tires to achieve the desired properties of rubber crumb and a generation system for executing this method. Through expert system simulation, the optimal process parameters for the trial processing stage are obtained to improve the effectiveness of water jet equipment in treating waste tires, and to solve the problem of long process parameter debugging time in the trial processing stage before mass production, in order to save costs, improve production efficiency, and avoid energy waste and pollution caused by thermal cracking, thereby reducing the impact on the environment.

The present disclosure proposes a method for generating processing parameters of tires to achieve the desired properties of rubber crumb, adapted to establish in a software program and executed in the following steps after read by a computer: establishing a predictive processing model through a waterjet tire destructing processing module, including the following steps: inputting waterjet data from a waterjet database; performing data analysis on the waterjet data to normalize the waterjet data; establishing the predictive processing model according to the normalized waterjet data; and training the predictive processing model to obtain the training result of a predictive chemical activity value; and outputting a processing suggestion parameter through a waterjet technology parameter optimization module and the predictive processing model.

The present disclosure also proposes a generation system, a adapted to be in signal connection with a high-power waterjet machine, the system including: storage drive used to store: a waterjet database, including a processing process parameter, a hardware module parameter, and a tire radius parameter; a waterjet tire destructing process module, used to establish the predictive processing model with the method for generating processing parameters of tires to achieve the desired properties of rubber crumb; and a waterjet technology parameter optimization module, used to output the processing suggestion parameter with the method for generating processing parameters of tires to achieve the desired properties of rubber crumb.

In order to make the present disclosure more obvious and understandable, embodiments are given below and explained in detail with the accompanying drawings.

### BRIEF DESCRIPTION OF THE DRA WINGS

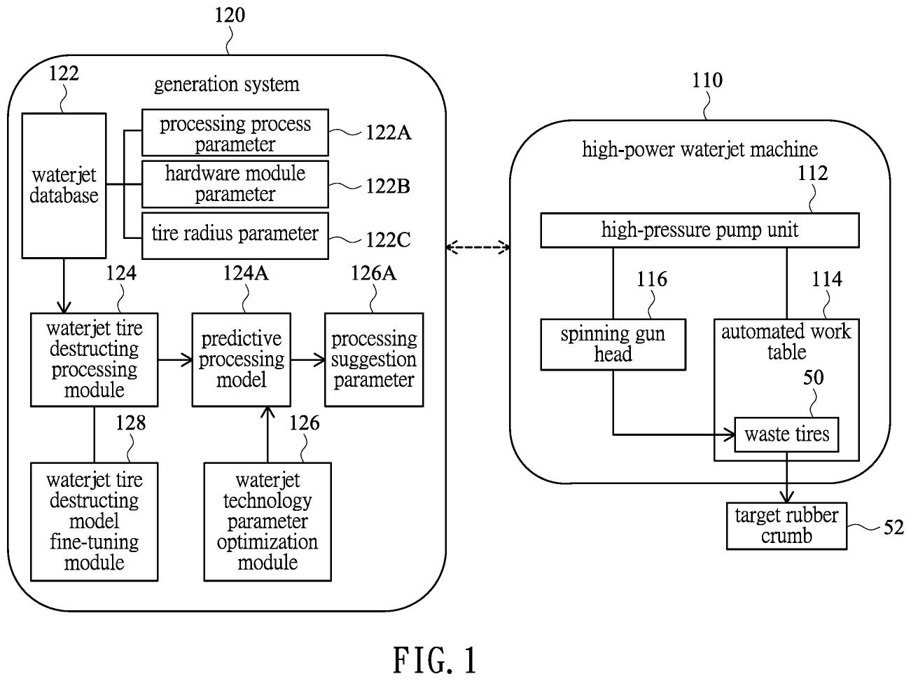

FIG. 1 is a schematic diagram of a system architecture of an embodiment according to the present disclosure; and

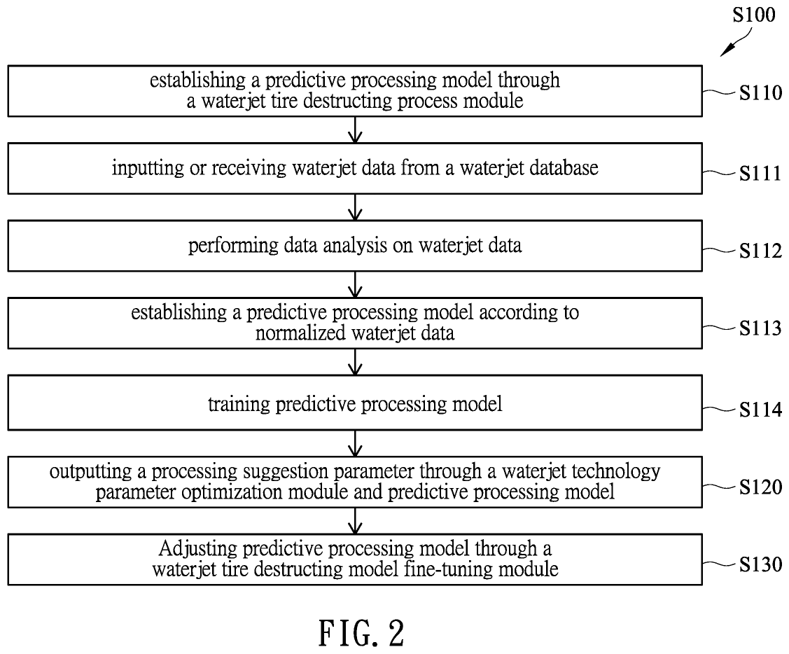

FIG. 2 is a flow chart of a method for generating processing parameters of tires to achieve the desired properties of rubber crumb according to the present disclosure,

### DETAILED DESCRIPTION

The following embodiments are enumerated and described in detail with reference to the accompanying drawings, but the provided embodiments are not intended to limit the scope of the present disclosure. In addition, the drawings are for illustrative purposes only and are not drawn to original size. To facilitate understanding, the same elements will be identified with the same symbols in the following description.

The terms “including”, “comprising”, “having”, etc. mentioned in the present disclosure are all open terms, that is, they mean “comprising but not limited to”.

In the description of each embodiment, when terms such as “first”, “second”, “third”, “fourth”, etc. are used to describe elements, they are only used to distinguish these elements from each other, and there is no restriction on the order or importance of these elements.

In the description of various embodiments, the so-called “coupling” or “connection” may refer to two or more components making direct physical or electrical contact with each other, or indirectly making physical or electrical contact with each other. “Coupling” or “connection” can also refer to the mutual operation or action of two or more components.

FIG. 1 is a schematic diagram of a system architecture of an embodiment according to the present disclosure, the waterjet equipment adopted by the present disclosure is a type of equipment that utilizes high-speed water jets generated under high-pressure to cut or process materials. Because high-speed water jets have extremely high energy density, they can be used to cut different types of materials, such as metal, glass, ceramics, stone, rubber, plastic, etc. Here, waste tires 50 are taken as an example; the waterjet equipment is used to process the recycling of the waste tires 50. The waterjet equipment of the present disclosure includes, for example, a high-power waterjet machine 110 and a generation system 120.

The high-power waterjet machine 110 of the present disclosure includes a high-pressure pump unit 112, an automated work table 114, and a spinning gun head 116, where the automated work table 114 is connected to the high-pressure pump unit 112, and the automated work table 114 is used to carry the objects to be processed (such as the waste tires of the present disclosure), and move them to a processing position; the spinning gun head 116 is a nozzle connected to the high-pressure pump unit 112, and the high-pressure pump unit 112 uses a high-pressure pump to compress a water body (clean water) to a very; high-pressure. Thereafter, the water body is ejected to form a narrow, high-speed rotating water stream through the spinning gun head 116 to form waterjet to cut the waste tires 50, allowing the waste tires 50 to be cracked to finally form target rubber crumb 52 after the waste tires 50 are cut.

For example, the high-power fluid pump conditions required by the high-pressure pump unit 112 are that the pressure is less than 43 k psi, and the nozzle diameter of the spinning gun head 116 is ranged between 0.1 mm and 0.5 mm, the movement conditions of the spinning gun head 116 are that the number of holes per gun is ranged from 3 to 6, and the rotating speed is ranged from 1000 rpm to 3500 rpm, the clamp movement speed is greater than 2 rpm; the above conditions can be adjusted according to the actual situation.

The generation system 120 is in signal connection with the high-power waterjet machine 110, for example, a processing suggestion parameter 126A is transmitted to the high-power waterjet machine 110 through internet connection or cloud, so as to allow today's water jet equipment to obtain the best effect, reducing the target rubber crumb 52 producing time. The generation system 120 is, for example, a computer, including a processor, a memory, a storage drive, a communication unit, an output unit, and etc.

The generation system 120 of the present disclosure includes a storage drive (not shown in the figure) used to store a waterjet database 122, a waterjet tire destructing module 124, a waterjet technology parameter optimization module 126, and a waterjet tire destructing model fine-tuning module 128; the above each module, for example is built in a software program, and this software program is stored in the storage drive, and is read by a computer, for example, the generation system 120 to execute a series of expected steps.

The waterjet database 122 is used to store a waterjet data set of historical waterjet processing data. For example, all waterjet processing parameters and corresponding rubber crumb chemical activity values are recorded according to the actual processing conditions to establish a waterjet database 122, in which the rubber crumb chemical activity value is related to the mesh number of rubber crumb.

The waterjet database 122 records include processing process parameters 122A, hardware module parameters 122B, and tire radius parameters 122C. The processing process parameters 122A include, for example, the output pressure, output flow rate, shooting distance, and the work table rotation speed of the automated work table 114; the hardware module parameter 122B includes, for example, the head rotation speed and the nozzle size of the spinning gun head 116; the tire radius parameter 122C is the radius of the waste tire 50.

The waterjet tire destructing module 124 is used to build a predictive processing model 124A to predict the rubber crumb chemical activity value; the waterjet technology parameter optimization module 126 is used to further output a processing suggestion parameter 126A, and the waterjet tire destructing model fine-tuning module 128 is used for users to fine-tune the predictive processing model 124A based on experimental data and rubber crumb chemical activity results of actual on-site processing conditions.

In an embodiment, a series of predictive steps executed by the generation system 120, for example, in addition to the waterjet database 122, can choose the waterjet tire destructing module 124, the waterjet technology parameter optimization module 126, or the waterjet tire destructing model fine-tuning module 128, choosing the combination thereof according to actual conditions. The following describes a method for generating processing parameters of tires S100 by referring to FIG. 2.

FIG. 2 is a flow chart of a method for generating processing suggestion parameters of tires according to the present disclosure. Referring to FIGS. 1 and 2, a method S100 for generating processing suggestion parameters of tires of the present disclosure, for example, is a software program built in the computer storage drive, and after it is read by the generation system 120, the following steps S110 to S130 are executed.

First, the step S110: building a predictive processing model 124A through a waterjet tire destructing module 124 is carried out. The step S110 further includes the following steps: first, step S111: inputting or receiving waterjet data from the waterjet database 122, where the waterjet data includes the processing process parameters 122A, the hardware module parameters 122B, and the tire radius parameters 122C in the waterjet database 122, where the processing process parameters 122A include, for example, the output pressure, output flow rate, shooting distance of the high-pressure pump unit 112, and the work table rotation speed of the automated work table 114; the hardware module parameters 122B, for example, include the gun head rotation speed and the nozzle size of the spinning gun head 116.

It can be seen from this that the present disclosure uses the output pressure of a high-pressure pump unit 112, the output flow rate of a high-pressure pump unit 112, the shooting distance of a high-pressure pump unit 112, the gun head rotation speed of a spinning gun head 116, the work table rotation speed of an automated work table 114, and a tire radius as the waterjet data.

Next, step S112 performs data analysis on the waterjet data. The data analysis includes obtaining the tangential velocity based on the work table rotation speed of the automated work table 114 and the tire radius in the tire radius parameter 122C, where the tangential velocity=work table rotation speed×tire radius×2π×10⁻³/60.

In addition, the step of performing data analysis on the waterjet data further includes performing data normalization on the waterjet data, where the data normalization means scaling the original data to the interval between 0 and 1 without changing the original distribution, so as to be able to eliminate the possible influences of different units, making different variables comparable.

In the embodiment, the original data of the output pressure, output flow rate, shooting distance of the high-pressure pump unit 112, the rotation speed of the spinning gun head 116, and the tangential velocity are normalized and scaled to the range of 0 to 1.

Next, the step S113 establishes a predictive processing model 124A based on the normalized water jet data. The present disclosure uses a regression analysis method to combine the normalized water jet data (such as the output pressure, output flow rate, shooting distance, and the rotation speed, nozzle size of the automated spinning gun head 116, and the tangential velocity are used to establish a predictive processing model 124A. The predictive processing model 124A is an AI (artificial intelligence) model, and the regression analysis can be established through

$$Y = {β}_{0} + {β}_{1} {x}_{i} + {β}_{2} {x}_{2} + … + {β}_{k} {x}_{k} .$$

It is a method of predicting data using a linear model function, in which single independent variables x: x1 represents the output pressure, x2 represents the output flow rate, x3 represents the nozzle size, x4 represents the pipe head speed, x5 represents the shooting distance, x6 represents the tangential velocity; β is the regression coefficient; Y is the prediction dependent variable, and the size of Y is predicted through X.

Next, the step S114 trains the predictive processing model 124A. For example, the processing data and rubber crumb mesh size are selected, and the processing data can be extracted from the waterjet database 122. Next, the upper and lower limits of the rubber crumb chemical activity interval are selected to train the predictive processing model 124A. The training method here can be trained by a regression analysis method, thereby obtaining a training result of a predicted chemical activity value. In other embodiments, a deep neural network (DNN) or other learning and training methods may be further selected according to the amount of training data.

Next, the predicted chemical activity value is compared with the chemical actual chemical activity value in the waterjet database 122, and the processing data and corresponding rubber crumb chemical activity recorded in the waterjet database 122 can be used to gradually improve the accuracy of the predictive processing model 124A.

Next, according to the range of the waterjet database 122 and the set chemical activity stage threshold, multiple stages are set for the rubber crumb chemical activity, so as to define the rubber crumb chemical activity as multiple hierarchical intervals. For example, the rubber crumb chemical activity is divided into three stages: high, medium and low stages. The threshold value of the chemical active stage is, for example, in the range of high activity, it is between 36% and 45%, in the range of medium activity, it is between 25% and 35%, and in the low activity range, it is between 12% and 24%, where the hierarchical intervals can be set by expert experience (such as the rubber crumb chemical activity experience value accessed by the waterjet database 122), and is divided into three stages: high, medium and low stages through the chemical activity stage threshold.

Next, the predictive processing model 124A, the normalized waterjet data, and the chemical activity stage threshold are accessed.

After step S110 is performed to establish the predictive processing model 124A, step S120 is then performed to output a processing suggestion parameter 126A through the waterjet technology parameter optimization module 126 and the predictive processing model 124A, thereby the user sets the chemical activity of the target rubber crumb, capable of obtaining the relevant waterjet data of the processing suggestion parameter 126A through step S120 and the relevant water jet data of the processing suggestion parameter 126A for processing by the high-power waterjet machine 110, the target rubber crumb chemical activity set by the user can be obtained.

Specifically, step S120 includes the following steps: First, setting the chemical activity value of the target rubber crumb. For example, a hierarchical stage can be selected from the three stages of high, medium and low chemical activity of the rubber crumb in the aforementioned step S110, or a chemical activity value can be customized. In addition, the step of setting the target rubber crumb chemical activity includes the following steps: setting the radius of the waste tire 50, setting the nozzle size of the spinning gun head 116, and the desired mesh number of the rubber crumb.

After the step of setting the target rubber crumb chemical activity, the waterjet technical parameter optimization module 126 uses a particle swarm optimization (PSO) algorithm to calculate multiple sets of waterjet data in the waterjet database 122 to find the waterjet data corresponding to the activity of the target rubber powder, and obtain the output pressure of the high-pressure pump unit 112, the output flow rate of the high-pressure pump unit 112, the shooting distance of the high-pressure pump unit 112, the gun head rotation speed of the spin gun head 116, the nozzle size of the spinning gun head 116, and the tangential velocity.

The above-mentioned example of the waterjet technology parameter optimization module 126 uses the particle swarm optimization algorithm to calculate multiple sets of waterjet data in the waterjet database 122, including the following steps: First, randomly generate multiple sets of waterjet data. Parameter particles, each group of parameter particles represents the corresponding waterjet data, that is, the output pressure of the high-pressure pump unit 112, the output flow rate of the high-pressure pump unit 112, the shooting distance of the high-pressure pump unit 112, the gun head speed of the spinning gun head 116, the nozzle size of the spinning gun head 116, the work table rotation speed of the automated work table 114, and the waterjet data of the tire radius are used as each set of parameter particles.

It should be noted that the above can further be used to preliminarily screen whether multiple sets of parameter particles exceed the parameter limits through preset parameter limits (such as expert experience). If so, multiple sets of parameter particles need to be randomly generated again; if not, continue the steps below. Next, the above multiple sets of parameter particles are imported into the predictive processing model 124A. The predictive processing model 124A is the model of the aforementioned regression analysis:

$$Y = {β}_{0} + {β}_{1} {x}_{1} + {β}_{2} {x}_{2} + … + {β}_{k} {x}_{k} .$$

That is, the predictive processing model 124A established by the waterjet tire destructing processing module 124 is introduced, and multiple sets of parameter particles are substituted into the predictive processing model 124A to predict the rubber crumb chemical activity.

Next, after multiple sets of parameter particles are imported into the predictive processing model 124A, multiple sets of rubber crumb prediction results are generated. That is, the rubber crumb chemical activity value corresponding to each set of parameter particles is used as the rubber crumb prediction result.

Next, the particle swarm optimization algorithm is used to find an approximate result value of the chemical activity value of the nearest similar target rubber crumb based on multiple sets of rubber crumb prediction results, and use it as the processing suggestion parameter 126A.

For example, through the fitness function: Compare the differences between multiple sets of rubber crumb prediction results and user demand values (multiple sets of rubber crumb prediction results). After multiple iterations, find the one with the smallest difference as the desired result. The processing suggestion parameters 126A for the chemical activity value of the target rubber crumb, in which the suggestion processing parameters 126A include the output pressure of the high-pressure pump unit 112, the output flow rate of the high-pressure pump unit 112, the shooting distance of the high-pressure pump unit 112, the gun head rotation speed of the spin gun head 116, the nozzle size of the spin gun head 116, and tangential velocity.

Proceed to step S130, and adjust the predictive processing model 124A through a waterjet tire destructing model fine-tuning module 128. The processing suggestion parameters 126A are output to the high-power waterjet machine 110 in each step S120, and step S130 can be executed after processing; or after the predictive processing model 124A is established in step S110, add experimental parameters and rubber crumb chemical activity results belonging to actual on-site processing conditions, and add a small amount of rubber crumb chemical activity data to execute step S130, so that the function of fine-tuning the predictive processing model 124A is achieved, and the accuracy of the predictive processing model 124A is improved.

Step S130 further includes the following steps: using the experimental parameters of the processing conditions and the rubber crumb chemical activity results as a processing data; then, inputting the aforementioned processing data and rubber crumb mesh number to retrain the predictive processing model 124A, thereby, the waterjet database 122 is updated and data analysis is performed again to achieve the purpose of fine-tuning the predictive processing model 124A.

In an embodiment, step S130 further includes the following steps: selecting a model, which includes an expert model, a modified model, or a customized model, where the expert model is a model generated based on expert experience; inputting the rubber crumb mesh number and adding processing data, the predictive processing model 124A can be adjusted or updated by selecting the expert model. The modified model is fine-tuned on existing models (such as the predictive processing model 124A trained in this disclosure); the customized model is a model generated based on the user's own expert experience, and the predictive processing model 124A can be adjusted or updated by selecting a customized model.

In summary, the present disclosure discloses the method for generating processing parameters of tires to achieve the desired properties of rubber crumb and a generation system for executing this method. Through expert system simulation, the optimal process parameters for the trial processing stage are obtained to improve the effectiveness of water jet equipment in treating waste tires, and to solve the problem of long process parameter debugging time in the trial processing stage before mass production, in order to save costs, improve production efficiency, and avoid energy waste and pollution caused by thermal cracking, thereby reducing the impact on the environment.

Although the present disclosure has been disclosed in the form of embodiments, they are not intended to limit the disclosure. Anyone with ordinary knowledge in the technical field may make slight changes and modifications without departing from the spirit and scope of the disclosure, so the scope of protection of this disclosure shall be subject to the scope of the patent application attached.

What is claimed is:

1. A method for generating processing parameters of tires to achieve the desired properties of rubber crumb, adapted to establish in a software program and executed in the following steps after read by a computer:
establishing a predictive processing model through a waterjet tire destructing processing module, comprising the following steps:
inputting waterjet data from a waterjet database;
performing data analysis on said waterjet data to normalize said waterjet data;
establishing said predictive processing model according to said normalized waterjet data; and
training said predictive processing model to obtain the training result of a predictive chemical activity value; and
outputting a processing suggestion parameter through a waterjet technology parameter optimization module and said predictive processing model.

2. The method according to claim 1, further comprising:
comparing said predictive chemical activity vale with an actual chemical vale in said waterjet database;
setting multiple stages for a rubber crumb chemical activity according to the range of said waterjet database and a chemical stage threshold; and
accessing said predictive processing model, said waterjet data after normalization, and said chemical activity stage threshold
after the step of obtaining the training result of said predictive chemical activity value.

3. The method according to claim 1, further comprising the following step:
using the output pressure of a high-pressure pump unit, the output flow rate of a high-pressure pump unit, the shooting distance of a high-pressure pump unit, the gun head rotation speed of a spinning gun head, the nozzle size of a spinning gun head, the work table rotation speed of an automated work table, and a tire radius as said waterjet data in the step of inputting said waterjet data from said waterjet database.

4. The method according to claim 3, further comprising the following steps:
utilizing the work table rotation speed of said automated work table and said tire radius to obtain a tangential velocity; and
performing a normalization step on the output pressure of said high-pressure pump unit, the output flow rate of said high-pressure pump unit, the shooting distance of said high-pressure pump unit, the gun heat rotation speed of said automated gun head, the nozzle size of said automated spinning gun head, and the radius of said tire
in the step of performing data analysis on said waterjet data.

5. The method according to claim 1, further comprising the following step:
using the regression analysis method to establish said normalized waterjet data said predictive processing model
in the step of establishing said predictive processing model according to said normalized waterjet data.

6. The method according to claim 1, further comprising the following step:
extracting a processing data from said waterjet database, selecting a rubber crumb mesh number, and selecting an upper and lower limit value of said rubber crumb chemical activity interval to train said predictive processing model
in the step of training said predictive processing model to obtain the training result of said predictive chemical activity value.

7. The method according to claim 1, further comprising the following steps:
setting the chemical activity value of a target rubber crumb, the radius of a waste tire, the nozzle size of a spinning gun head, and the mesh number of desired rubber crumb; and
using said waterjet technology parameter optimization module with a particle swarm optimization algorithm to calculate multiple sets of waterjet data in said waterjet database to find said waterjet data corresponding to said chemical activity of said target rubber crumb as said processing suggestion parameter
in the step of outputting said processing suggestion parameter through said waterjet technology parameter optimization module and said predictive processing model.

8. The method according to claim 7, further comprising the following steps:
randomly generating multiple groups of parameter particles, and each group of parameter particles representing corresponding waterjet data;
importing said multiple sets of parameter particles into said predictive processing model to generate multiple sets of rubber crumb prediction results; and
using said multiple sets of rubber crumb prediction results with said particle swarm optimization algorithm to find an approximate result value that is most similar to the chemical activity value of said target rubber crumb as said processing suggestion parameter
in the step of using said waterjet technology parameter optimization module with a particle swarm optimization algorithm.

9. The method according to claim 1, further comprising the following step:
adjusting said prediction processing model through a waterjet tire destructing model fine-tuning module.

10. The method according to claim 9, further comprising the following steps:
using the experimental parameters and the rubber crumb chemical activity results according to processing conditions as processing data; and
Inputting said processing data and a rubber crumb mesh number to retrain said prediction processing model
in the step of adjusting said prediction processing model through a waterjet tire destructing model fine-tuning module.

11. A target rubber crumb processing process parameter generation system, adapted to be in signal connection with a high-power waterjet machine, said system comprising: a storage drive used to store:
a waterjet database, comprising a processing process parameter, a hardware module parameter, and a tire radius parameter;
a waterjet tire destructing process module, as claimed in a method for generating processing parameters of tires to achieve the desired properties of rubber crumb of claim 9, used to establish said predictive processing model;
a waterjet technology parameter optimization module, as claimed in a method for generating processing parameters of tires to achieve the desired properties of rubber crumb of claim 9, used to output said processing suggestion parameter; and
a waterjet tire destructing model fine-tuning module, as claimed in a method for generating processing parameters of tires to achieve the desired properties of rubber crumb of claim 9, used to adjust said predictive processing model.

12. (canceled)
